(19) United States
(12) Patent Application Publication
(10) Pub. No.: US 2013/0189597 A1
(43) Pub. Date: Jul. 25, 2013

(54) FUEL CELL SYSTEM AND METHOD OF OPERATING THE SAME AT LOW TEMPERATURE

(71) Applicant: Samsung Electronics Co., Ltd., Suwon-si (KR)

(72) Inventors: Young-jae KIM, Seoul (KR); Jin S. HEO, Hwaseong-si (KR); Hye-jung CHO, Anyang-si (KR); Jong-rock CHOI, Seoul (KR)

(73) Assignee: SAMSUNG ELECTRONICS CO., LTD., Suwon-si (KR)

(21) Appl. No.: 13/733,606

(22) Filed: Jan. 3, 2013

(30) Foreign Application Priority Data
Jan. 19, 2012 (KR) 10-2012-0006408

(51) Int. Cl. H01M 8/04

(52) U.S. Cl. CPC H01M 8/04037; H01M 8/04701
USPC 429/415; 429/436; 429/429

(57) ABSTRACT

A fuel cell system includes a fuel cell which generates power using a fuel; peripheral devices for operating the fuel cell and supplying power generated by the fuel cell to loads; and a heating module which heats at least one of the fuel cell and the peripheral devices using heat generated by a semiconductor device attached to the at least one of the fuel cell and the peripheral devices.

### CROSS-REFERENCE TO RELATED APPLICATIONS

This application claims priority to Korean Patent Application No. 10-2012-0006408, filed on Jan. 19, 2012, and all the benefits accruing therefrom under 35 U.S.C. §119, the content of which in its entirety is herein incorporated by reference.

### BACKGROUND

1. Field

The disclosure relates to fuel cell systems and methods of operating the fuel cell systems at low temperatures.

2. Description of the Related Art

A fuel cell is an environmental-friendly alternative energy source for generating electric energy from materials abundant on the Earth, e.g., hydrogen, and is becoming popular together with a solar cell, for example. While electrochemical reactions inside a fuel cell may occur substantially smoothly at a temperature above about zero Celsius, when a fuel cell is operated at a temperature below about zero Celsius, performance and durability of the fuel cell may be deteriorated, and the fuel cell and peripheral devices for operating the fuel cell may freeze.

### SUMMARY

Provided are fuel cell systems and methods of operating the fuel cell systems at low temperatures.

Provided is a computer readable recording media having recorded thereon computer programs for implementing the methods on computers.

Additional aspects will be set forth in part in the description which follows and, in part, will be apparent from the description, or may be learned by practice of the presented embodiments.

According to an embodiment of the invention, a fuel cell system includes a fuel cell which generates power using a fuel; peripheral devices for operating the fuel cell and supplying the power generated by the fuel cell to loads; and a heating module which heats at least one of the fuel cell and the peripheral devices using heat generated by a semiconductor device attached to the at least one of the fuel cell and the peripheral devices.

In an embodiment, the semiconductor device may be a transistor, and the heating module may heat the at least one of the fuel cell and the peripheral devices using heat generated by the transistor while the transistor is being switched.

In an embodiment, the peripheral devices may include a controller which controls heat generation of the semiconductor device by switching the transistor by outputting pulse signal, voltage of which changes in a shape of pulse having a predetermined frequency, to the transistor, and the heating module heats the at least one of the fuel cell and the peripheral devices using the heat generated by the transistor, which is switched substantially in proportion to the predetermined frequency.

In an embodiment, the transistor may be a metal oxide semiconductor field effect transistor (“MOSFET”).

In an embodiment, the fuel cell system may further include a temperature sensor which is attached to the at least one of the fuel cell and the peripheral devices and detects temperature of the at least one of the fuel cell and the peripheral devices, where the heating module may heat the at least one of the fuel cell and the peripheral devices using the heat generated by the semiconductor device based on the temperature detected by the temperature sensor.

In an embodiment, the peripheral devices may include a controller which compares the temperature detected by the temperature sensor to a predetermined temperature and controls heat generation of the semiconductor device based on a result of the comparison.

In an embodiment, the controller may induce heat generation of the semiconductor device if the temperature detected by the temperature sensor is lower than the predetermined temperature, and the controller may start the fuel cell if the temperature detected by the temperature sensor is not lower than the predetermined temperature.

In an embodiment, the peripheral devices may include a predetermined pump, and includes a controller which operates the predetermined pump based on the temperature of the at least one of the fuel cell and the peripheral devices to circulate a fluid remaining in the fuel cell system, such that the peripheral devices and pipes on a path, in which the fluid is recycled, are warmed.

In an embodiment, the semiconductor device may be shared by an electric circuit included in the heating module and an electric circuit included in a peripheral device of the peripheral devices. If temperature of at least one of the fuel cell and the peripheral devices is lower than the predetermined temperature, the semiconductor device is used to heat the at least one of the fuel cell and the peripheral devices. After the fuel cell is started, the semiconductor device is used for operating the peripheral device including the electric circuit.

In an embodiment, the peripheral device may be a recycle pump for circulating a fuel in a predetermined path inside the fuel cell system, and the electric circuit included in the peripheral device may be an operation circuit of the recycle pump.

According to another embodiment of the invention, a method of operating the fuel cell system includes receiving temperature of at least one of a fuel cell and peripheral devices of the fuel cell system; comparing the received temperature to a first predetermined temperature; and controlling heat generation of a semiconductor device attached to the at least one of the fuel cell and the peripheral devices based on a result of the comparison.

In an embodiment, the semiconductor device may be a transistor, and the controlling the heat generation of the semiconductor device may include switching the transistor by controlling a voltage input to the transistor based on a result of the comparison.

In an embodiment, the switching the transistor may include outputting pulse signal, voltage of which changes in a shape of pulse having a predetermined frequency to the transistor, based on the result of the comparison.

In an embodiment, the transistor may be a MOSFET.

In an embodiment, the method may further include inducing heat generation of the semiconductor device if the received temperature is lower than the first predetermined temperature; and starting the fuel cell, if the received is not lower than the first predetermined temperature.

In an embodiment, the method may further include, if the received temperature is lower than the first predetermined temperature, inducing heat generation of the semiconductor device by outputting pulse signal, voltage of which changes in a shape of pulse having a predetermined frequency, to the semiconductor device, and, after the fuel cell is started, operating a peripheral device having an electric circuit, to which the semiconductor device is applied, by outputting a signal different from the pulse signal outputted to the semiconductor device.

In an embodiment, the method may further include comparing the received temperature to a second predetermined temperature higher than the predetermined temperature; and, if the received temperature is lower than the second predetermined temperature and is not lower than the first predetermined temperature, warming the peripheral devices and pipes on a path, in which a fluid remaining in the fuel cell system is circulated by circulating the fluid, by operating a predetermined pump from among the peripheral devices.

In an embodiment, the method may further include starting the fuel cell, if the received temperature is not lower than the second predetermined temperature.

In an embodiment, the method may further include, if the received temperature is lower than the first predetermined temperature, inducing heat generation of the semiconductor device, where the semiconductor is attached to a predetermined pump from among the peripheral devices; and warming the peripheral devices and pipes on a path, in which the fluid remaining in the fuel cell system is circulated by circulating the fluid, by operating the predetermined pump heated by the semiconductor device.

According to another embodiment of the invention, there is provided a computer readable recording medium having recorded thereon a computer program for implementing a method of operating the fuel cell system, the method including receiving temperature of at least one of a fuel cell and peripheral devices of the fuel cell system; comparing the received temperature to a predetermined temperature; and controlling heat generation of a semiconductor device attached to the at least one of the fuel cell and the peripheral devices, according to a result of the comparison.

### BRIEF DESCRIPTION OF THE DRAWINGS

These and/or other features will become apparent and more readily appreciated from the following description of the embodiments, taken in conjunction with the accompanying drawings of which:

FIGS. 1A and 1B are equivalent circuit diagrams showing an embodiment of a metal oxide semiconductor field effect transistor (“MOSFET”) and parasitic components of the MOSFET;

FIGS. 2A to 2D are diagrams showing power loss during the MOSFET shown in FIG. 1 is being switched;

FIGS. 3A to 3C are diagrams showing an embodiment of a heating module according to the invention;

FIG. 4 is a diagram showing an embodiment of a fuel cell system according to the invention;

FIG. 5 is a flowchart showing an embodiment of a method of operating a fuel cell system at a low temperature according to the invention;

FIG. 6 is a diagram showing an alternative embodiment of a fuel cell system according to the invention;

FIG. 7 is a flowchart showing an alternative embodiment of a method of operating a fuel cell system at a low temperature according to the invention;

FIG. 8 is a diagram showing another alternative embodiment of a fuel cell system according to the invention; and

FIG. 9 is a flowchart showing another alternative embodiment of a method of operating a fuel cell system at a low temperature according to the invention.

### DETAILED DESCRIPTION

The invention will be described more fully hereinafter with reference to the accompanying drawings, in which exemplary embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Reference will now be made in detail to embodiments, examples of which are illustrated in the accompanying drawings, where like reference numerals refer to the like elements throughout. In this regard, the embodiments described herein may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

A fuel cell system includes fuel cells, which generate power using a fuel, and a balance of plants (“BOP”), which are peripheral devices for operating the fuel cells and supplying power generated by the fuel cells to loads. Since embodiments of the invention are related to means for defreezing fuel cells and peripheral devices in a case where the fuel cells and the peripheral devices are frozen, detailed descriptions of a stack and a BOP constituting fuel cells will be omitted for convenience of description. Generally, fuel cells are designed as a stack in which a plurality of cells are combined in series or in parallel in correspondence to power demanded by a load. Hereinafter, a single cell and a stack in which a plurality of cells are arranged will be collectively referred to as a fuel cell.

The most widely used types of semiconductor devices, which are major components of electric circuits, may include a diode and a transistor. Generally, when a current flows through a semiconductor device, heat is emitted from the semiconductor device. Since heat emission of a semiconductor device causes malfunction or breakdown of an electric circuit, semiconductor devices and electric circuits are generally designed to reduce heat emission of the semiconductor devices.

Hereinafter, techniques for heating at least one of a fuel cell and peripheral devices thereof using heat emission of a semiconductor device will be described. Particularly, since a semiconductor device consumes less power as compared to conventional heat generating device, such as a hot wire and a resistor, for example, power increase consumed by a fuel cell system due to addition of a device heating the fuel cell system may be substantially reduced.

A transistor emits a large amount of heat while being switched, and thus a transistor may be one of the most popular devices emitting large amounts of heat. Transistors may be categorized into bipolar junction transistors (“BJT”) and field effect transistors (“FET”) according to materials constituting the transistors. A metal oxide semiconductor FET (“MOSFET”) is a type of FETs and is widely used for electronic switches due to features including high switching speed and fine efficiency at a low voltage. For example, MOSFETs are used in a direct-current-to-direct-current (“DC-DC”) converter of a fuel cell system and a motor operating circuit of a pump. Hereinafter, techniques for heating at least one of a fuel cell and peripheral devices thereof using a MOSFET will be described. However, it will be understood by one of ordinary skill in the art that the MOSFET may be replaced with other semiconductor devices having similar characteristics and the embodiments below may be easily modified based on the replacement.

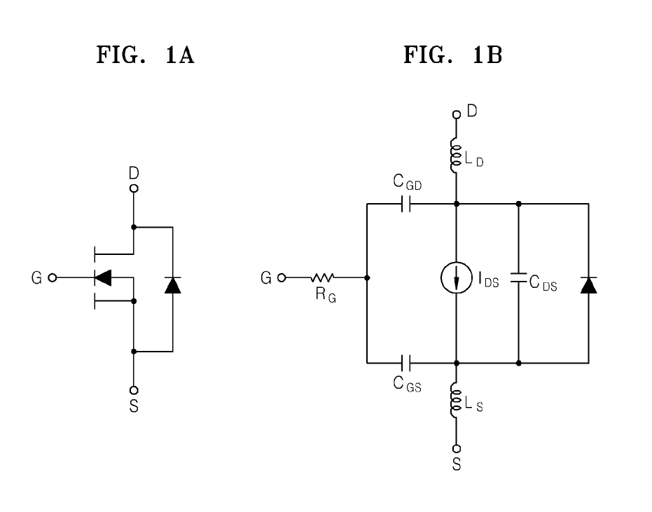

FIGS. 1A and 1B are equivalent circuit diagrams showing an embodiment of a MOSFET and parasitic components of the MOSFET. FIG. 1A shows a symbol of an N-channel MOSFET including a body drain diode. As shown in FIG. 1A, three terminals of the MOSFET are referred to as a source S, a gate G and a drain D, respectively. In an N-channel MOSFET, if a voltage between the gate G and the source S exceeds a critical voltage, a channel region, which includes free electrons and interconnects the drain and the source, is formed, and a current may flow between the drain D and the source S via the channel region. A MOSFET has a specific critical voltage according to a structure and materials constituting the MOSFET. Accordingly, a current flowing between the drain D and the source S may be controlled by a voltage between the gate G and the source S.

FIG. 1B shows an equivalent circuit diagram of the MOSFET shown in FIG. 1A. As shown in FIG. 1B, the MOSFET has various parasitic capacitances, such as a parasitic capacitance C_{GD} between the gate G and the drain D, a parasitic capacitance C_{GS} between the gate G and the source S, a parasitic capacitance C_{DS} between the drain D and the source S, a parasitic inductance L_{D} at the drain D terminal, a parasitic inductance L_{S} at the source S terminal and a parasitic resistance R_{G} at the gate G terminal, for example. The parasitic components are components that are inherently formed during fabrication of the MOSFET. It is generally known that parasitic components are formed at junctions of terminals, parasitic inductances are formed at leads of terminals, and parasitic resistances are formed based on resistances of materials constituting the MOSFET. The parasitic components deteriorate efficiency of the MOSFET and the parasitic components induce heat generation of the MOSFET, and thus the MOSFET may be designed to have a structure with suppressed parasitic components.

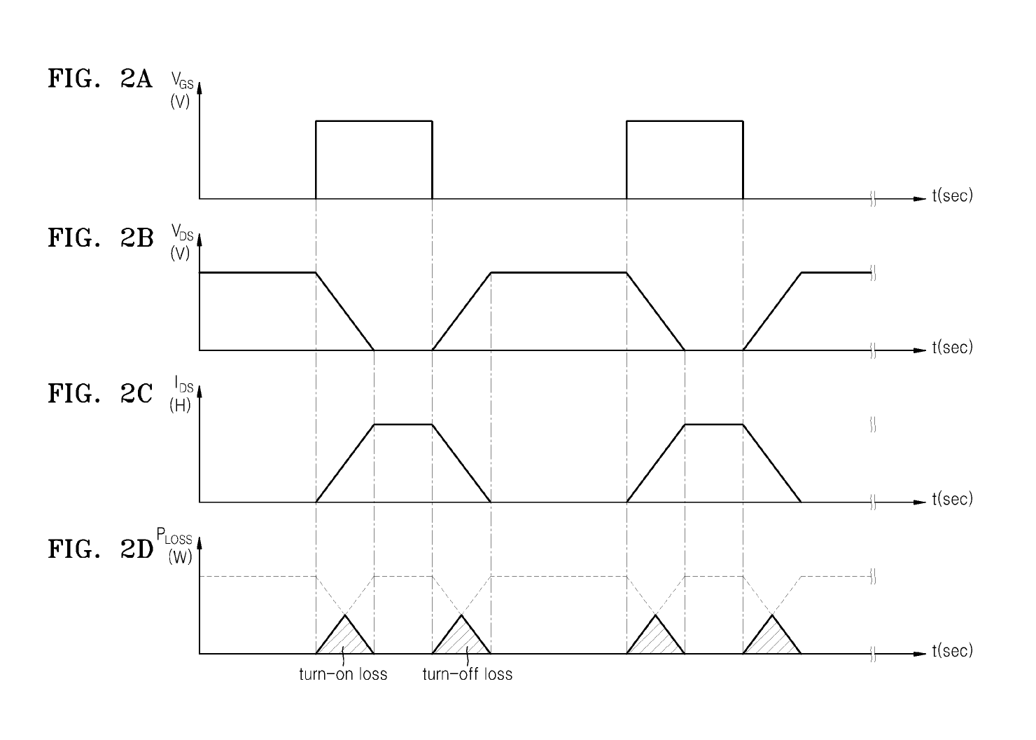

FIGS. 2A to 2D are diagrams showing power loss during switching of the MOSFET shown in FIG. 1. As shown in FIG. 2A, if a voltage V_{GS} between the gate G and the source S of the MOSFET rises and exceeds a critical voltage, a current I_{DS} flows between the drain D and the source S. As a result, as shown in FIG. 2B and FIG. 2C, a voltage V_{DS} between the drain D and the source S drops and the current I_{DS} between the drain D and the source S rise. When the drop of the voltage V_{DS} between the drain D and the source S ends and the rise of the current I_{DS} between the drain D and the source S ends, the MOSFET is turned on. Due to the parasitic components as shown in FIG. 1B, the voltage V_{DS} between the drain D and the source S does not drop immediately, and the current I_{DS} between the drain D and the source S does not rise immediately, in correspondence to the rapid rising of the voltage V_{GS} between the gate and the source.

as shown in FIG. 2B and FIG. 2C, the voltage V_{DS} between the drain D and the source S slowly drops and the current I_{DS} between the drain D and the source slowly rises due to the parasitic components as shown in FIG. 1B. Accordingly, due to the parasitic components as shown in FIG. 1B, the MOSFET is delayed from being turned on. As the MOSFET is delayed from being turned on, as shown in FIG. 2D, power P_{LOSS} is generated at the MOSFET during the turn-on of the MOSFET from the voltage V_{DS} between the drain D and the source S and the current I_{DS} between the drain D and the source S, and the power P_{LOSS} is dissipated in the form of heat energy. The dissipating power P_{LOSS} is referred to as turn-on loss.

As shown in FIG. 2A, when the voltage V_{GS} between the gate G and the source S of the MOSFET drops below the critical voltage, the channel region interconnecting the drain D and the source S disappears, and thus a current may not flow between the drain D and the source S. As a result, as shown in FIG. 2C and FIG. 2D, the voltage V_{DS} between the drain D and the source S rises, whereas the current I_{DS} between the drain D and the source S drops. When the rise of the voltage V_{DS} between the drain D and the source S ends and the drop of the current I_{DS} between the drain D and the source S ends, the MOSFET is turned off. Due to the parasitic capacitances as shown in FIG. 1B, the voltage V_{DS} between the drain D and the source S does not rise immediately, and the current I_{DS} between the drain D and the source S does not drop immediately, in correspondence to the rapid drop of the voltage V_{GS} between the gate G and the source S of the MOSFET.

As shown in FIG. 2B and FIG. 2C, due to the parasitic capacitances as shown in FIG. 1B, the voltage V_{DS} between the drain D and the source S slowly rises and the current I_{DS} between the drain D and the source S slowly drops. Accordingly, due to the parasitic components as shown in FIG. 1B, the MOSFET is delayed from being turned off. As the MOSFET is delayed from being turned off, as shown in FIG. 2D, power P_{LOSS} is generated at the MOSFET during the turn-off of the MOSFET from the voltage V_{DS} between the drain D and the source S and the current I_{DS} between the drain D and the source S, and the power P_{LOSS} is dissipated in the form of heat energy. The dissipating power P_{LOSS} is referred to as turn-off loss.

Changing state of the MOSFET from turn-off state to turn-on state or vice versa by controlling a voltage input to the gate of the MOSFET is referred to as switching of the MOSFET. Therefore, the turn-on loss and the turn-off loss described above are referred to as switching loss of the MOSFET. Since switching loss of the MOSFET occurs every time the MOSFET is switched, the higher the switching frequency of the MOSFET is, the greater the switching loss of the MOSFET becomes. Therefore, the MOSFET emits more heat. Therefore, when the MOSFET may be used for heating a fuel cell and peripheral devices in embodiments, which will be described in detail described below, the MOSFET is switched at a higher frequency as compared to the case in which the MOSFET is used for its general purposes. If switching frequency of the MOSFET is too high, the MOSFET may malfunction or may be burnt out due to heat generated by the MOSFET. Therefore, the highest switching frequency of the MOSFET may be set within a range of frequencies in which the MOSFET functions normally.

In an embodiment, the total power loss Pₜₒₜₐₗ at the MOSFET may be expressed as Equation 1 below. In Equation 1, D denotes duty cycle of the pulse waveform shown in FIG. 1A, that is, a ratio between a length of a voltage duration exceeding a critical voltage and a period of the pulse waveform, and R_{IDS} denotes a resistance between the drain and the source. In other words, D×I_{DS}²×R_{IDS} denotes power consumed by the resistance between the drain D and the source S while the MOSFET is turned on, and f denotes switching frequency of the MOSFET. Although D×I_{DS}²×R_{IDS} may contribute heat emission of the MOSFET, heat generated due to D×I_{DS}²×R_{IDS} is substantially low as compared to heat generated by parasitic components.

Pₜₒₜₐₗ=D×I_{DS}²×R_{DS}+(Pᵣ+P_{f})×f Equation 1

Equation 2 below indicates efficiency of the MOSFET. In Equation 2, Pᵢₙ denotes a total power input to the MOSFET. According to Equation 2, efficiency of the MOSFET becomes close to about 100% as power lost at the MOSFET is reduced, that is, heat generated during switching of the MOSFET is reduced.

$$η = \frac{{P}_{i n} - {P}_{total}}{{P}_{i n}} \times 100 \qquad Equation 2$$

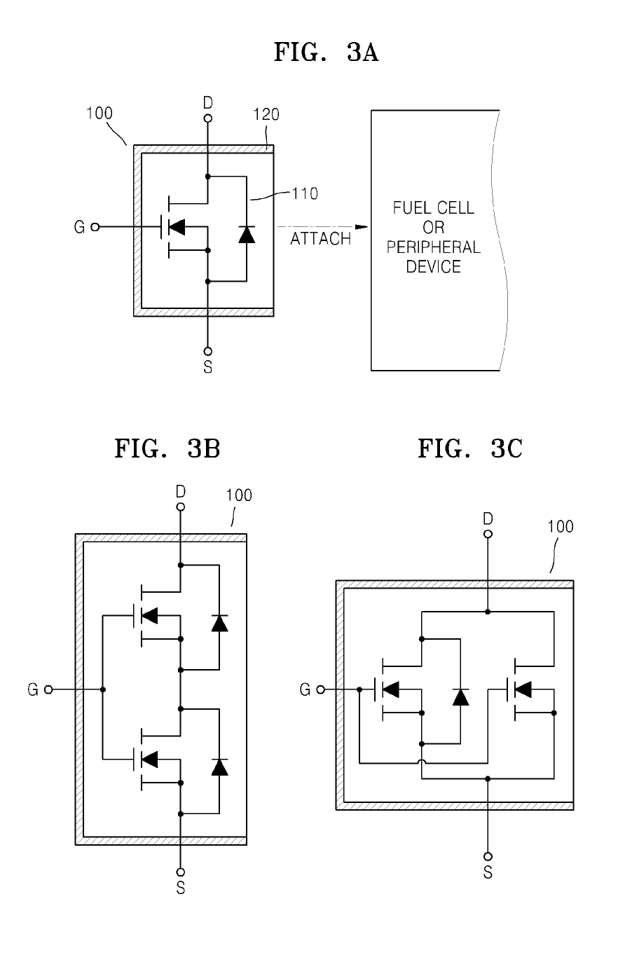

FIGS. 3A to 3C are diagrams showing an exemplary embodiment of a heating module 100 according to the invention. FIG. 3A shows the heating module 100 having the simplest structure, in which only one MOSFET is included. The heating module 100 shown in FIG. 3A includes a MOSFET 110 attached to a fuel cell or one of the peripheral devices and a heat insulator 120 surrounding the MOSFET 110.

The heat insulator 120 is a sheet including a material having low heat conductivity and surrounds the MOSFET 110 except a surface of the MOSFET 110 to be attached to a device, such that heat generated by the MOSFET 110 is transmitted only to the device, to which the MOSFET 110 is attached. The source of the MOSFET 110 may be grounded, a constant current used for heat emission of the MOSFET 110 may be input to the drain D of the MOSFET 110, and a pulse signal for switching the MOSFET 110 may be input to the gate G of the MOSFET 110. When the pulse signal as shown in FIG. 2A is input to the gate G of the MOSFET 110, the MOSFET 110 is switched, and the heating module 100 heats the device as shown in FIG. 3A using heat generated during the switching of the MOSFET 110.

In an embodiment, the heating module 100 may include a plurality of MOSFETs that are connected in series to improve heat generating performance of the heating module 100. In one embodiment, for example, as shown in FIG. 3B, the heating module 100 may include two MOSFETs connected in series. In an alternative embodiment, the heating module 100 may also include a plurality of MOSFETs connected in parallel. In one embodiment, for example, as shown in FIG. 3C, the heating module 100 may include two MOSFETs connected in parallel. In the embodiment shown in FIG. 3B, a voltage between the drain D and the source S for the heating module 100 may be set to be about twice a voltage between the drain D and the source S for the heating module 100 in the exemplary embodiment of FIG. 3A. In the embodiment of FIG. 3C, a current between the drain D and the source S for the heating module 100 may be set to be about twice a current between the drain D and the source S for the heating module 100 in the embodiment of FIG. 3A. In an embodiment, the serial structure shown in FIG. 3B or the parallel structure shown in FIG. 3C may be determined based on characteristics of power supplied to the heating module 100, e.g., characteristics of power charged to a battery of a fuel cell system. In an alternative embodiment, the heating module 100 may includes MOSFETs that are connected to each others in a combination of the serial structure shown in FIG. 3B and the parallel structure shown in FIG. 3C.

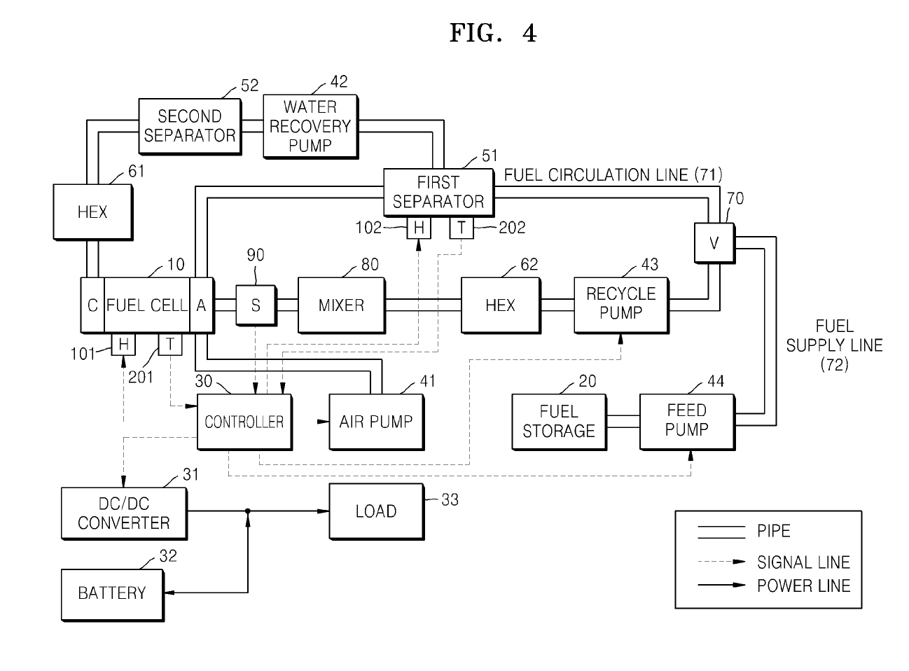

FIG. 4 is a diagram showing an embodiment of a fuel cell system according to the invention. Referring to FIG. 4, an embodiment of the fuel cell system includes a fuel cell 10, a fuel storage 20, a controller 30, a direct-current-to-direct-current (“DC/DC”) converter 31, a battery 32, an air pump 41, a water recovery pump 42, a recycle pump 43, a feed pump 44, a first separator 51, a second separator 52, a first heat exchanger 61 (“HEX”), a second heat exchanger (“HEX”) 62, a valve module 70, a mixer 80, a sensor (“S”) 90, heating modules (“H”), e.g., a first heating module 101 and a second heating module 102, and temperature sensors (“T”), e.g., a first temperature sensor 201 and a second temperature sensor 202. Generally, peripheral devices for operating a fuel cell and supplying power generated by the fuel cell to loads are referred to as BOP. The BOP may include Mechanical BOP (“MBOP”), which are peripheral devices for operating the fuel cell 10 by supplying fuel and air to the fuel cell 10, and Electrical BOP (“EBOP”), which are peripheral devices for supplying power generated by the fuel cell to loads by converting output voltage of the fuel cell.

As shown in FIG. 4, components of the MBOP are interconnected via pipes. In an embodiment, the fuel cell system shown in FIG. 4 may further include devices other than the components shown in FIG. 4. In one embodiment, for example, the fuel cell system may further include a thermistor attached to the fuel cell 10 to detect temperature of the fuel cell 10, filters installed at pipes connected to the sensor 90 to remove impurities in fuel flowing in the pipes, and fans installed at the first heat exchanger 61 and the second heat exchanger 62 to cool the first heat exchanger 61 and the second heat exchanger 62. In an alternative embodiment, it will be understood by one of ordinary skill in the art that the embodiment shown in FIG. 4 may be modified by omitting a part of the components shown in FIG. 4. In one embodiment, for example, from among the component of the fuel cell system shown in FIG. 4, at least one of the second separator 52, the first heat exchanger 61 and the second heat exchanger 62 may be omitted. However, in such an embodiment, when the component(s) are omitted, water recovery efficiency and/or cooling efficiency of the fuel cell system may be deteriorated.

The fuel cell 10 is a power generating device, which produces direct current (“DC”) power, by directly converting chemical energy of a fuel to electric energy via an electrochemical reaction. In an embodiment, the fuel cells may include a solid oxide fuel cell (“SOFC”), a polymer electrolyte membrane fuel cell (“PEMFC”), a direct methanol fuel cell (“DMFC”), for example. In an embodiment, as shown in FIG. 4, a fuel cell system may employ a MBOP for operating a DMFC. In an alternative embodiment, the technical features described below may be applied to other types of fuel cells.

In a DMFC, unlike an indirect methanol fuel cell in which methanol is reformed to increase hydrogen concentration thereof, methanol and water directly react with each other at the anode A of the fuel cell 10 and hydrogen ions and electrons are generated. Accordingly, in the DMFC, methanol is not reformed such that a size of a DMFC may be substantially reduced, and applied to a portable fuel cell system.

A reaction of CH₃OH+H₂O->6H⁺+6e⁻+CO₂ occurs at the anode A of a DMFC, whereas a reaction of 3/2O₂+6H⁺+6e⁻->3H₂O occurs at the cathode C of the DMFC. Protons H⁺ are transmitted via a proton exchange membrane inside the fuel cell 10, whereas electrons e⁻ are transmitted from the anode A to the cathode C via an external circuit. Accordingly, power is generated by the transmissions of protons H⁺ and electrons e⁻. In an embodiment, a catalyst may be included in a DMFC for smooth reaction in the fuel cell 10. Generally, the catalyst is formed of platinum and may be deteriorated if temperature during the reaction is too high. Therefore, pure methanol is not supplied to the fuel cell 10. In an embodiment, methanol may be diluted by a suitable amount of water to be supplied, that is, a methanol aqueous solution with a suitable concentration to the fuel cell 10. Hereinafter, a methanol aqueous solution supplied via an inlet at the anode A of the fuel cell 10 will be referred to as a fuel.

As described above, suitable amounts of methanol, water and air are supplied to the fuel cell 10 such that the reaction in the fuel cell 10 is smoothly performed while effectively preventing deterioration of the fuel cell 10. The controller 30 controls the air pump 41, the feed pump 44, the recycle pump 43 and the water recovery pump 42 to adjust amounts of fuel, water and air supplied to the fuel cell 10 based on concentration and temperature of the fuel detected by the sensor 90. The controller 30 may be embodied using a microcontroller. The fuel cell 10 generates power using a fuel of a suitable concentration supplied from the mixer 80 via the inlet at the anode A of the fuel cell 10. During power generation of the fuel cell 10, a by-product of the reaction, e.g., carbon dioxide, and unreacted fuel are discharged via an outlet at the anode A of the fuel cell 10, whereas another by-product of the reaction, e.g., water, is discharged via an outlet at the cathode C of the fuel cell 10.

The first separator 51 recovers methanol and water by separating the methanol and the water from the by-products and unreacted fuel that are discharged via the outlet at the anode A of the fuel cell 10. The by-product discharged via the outlet at the cathode C of the fuel cell 10 is a fluid heated by the reaction heat at the fuel cell 10 and contains water in the form of vapors. As the fluid passes through the first heat exchanger 61, the fluid is cooled via heat exchange process of the first heat exchanger 61, where water is partially recovered. The second separator 52 recovers water by separating the water from the cooled by-product and discharges the remaining by-product after the recovery, e.g., carbon dioxide, to outside. The first separator 51 and the second separator 52 may separate methanol and water from the by-products and unreacted fuel that are discharged from the fuel cell 10 via centrifugal separation, for example. The water recovery pump 42 sucks water received by the second separator 52 and discharges the water to the first separator 51. Accordingly, the first separator 51 discharges a fuel having low concentration, in which methanol recovered by the first separator 51 and water recovered by the first and second separators 51 and 52 are mixed.

The fuel storage 20 is a container, in which high concentration fuel, e.g., about 100% methanol, is stored, and the fuel storage 20 may be configured to have any of various shapes, such as a cylindrical shape, a box shape, etc. The fuel storage 20 may be configured to allow fuel to be refilled. In an embodiment, the fuel storage 20 may be configured to be attached and detached to and from the fuel cell system shown in FIG. 4 and is generally referred to as cartridges.

The valve module 70 is inserted to a location at which a fuel circulation line 71 and a fuel supply line 72 are connected to each other and controls flow of a low concentration fuel circulating from the fuel cell 10 to the fuel cell 10 via the fuel circulation line 71 and flow of a high concentration fuel supplied from the fuel storage 20 to the fuel cell 10 via the fuel supply line 72. In an embodiment, the fuel circulation line 71 may be pipes at a path in which unreacted fuel discharged from the fuel cell 10 flows back to the fuel cell 10, whereas the fuel supply line 72 may be pipes at a path in which a new fuel supplied from the fuel storage 20 to the fuel cell 10 flows.

According to fuel flow control of the valve module 70, the recycle pump 43 sucks, from the valve module 70, at least one of a low concentration fuel transported via the fuel circulation line 71 and a high concentration fuel transported via the fuel supply line 72 and discharges the sucked fuel to the mixer 80 via the second heat exchanger 62. As described above, the recycle pump 43 pumps to circulate a fuel in a predetermined path inside the fuel cell system, that is, peripheral devices other than the fuel storage 20 and the feed pump 44 on the fuel supply line 72, the fuel cell 10 and pipes interconnecting therebetween. As a fuel discharged by the recycle pump 43 passes through the second heat exchanger 62, temperature of the fuel is adjusted via heat exchange process of the second heat exchanger 62. The mixer 80 mixes a low concentration fuel and a high concentration fuel, which are discharged by the recycle pump 43, and provides a fuel of a suitable concentration formed via the mixing process to the fuel cell 10.

The first heat exchanger 61 is located at a predetermined location of a pipe line, in which water discharged from the fuel cell 10 flows, e.g., the outlet of the cathode of the fuel cell 10, and controls temperature of the water discharged via the outlet of the cathode of the fuel cell 10. The second heat exchanger 62 is located at a predetermined location of a pipe line, in which fuel supplied to the fuel cell 10 flows, e.g., a location between the recycle pump 43 and the mixer 80, and controls temperature of fuel supplied via the inlet of the anode A of the fuel cell 10. The first heat exchanger 61 and the second heat exchanger 62 may be embodied as metal tubes or tanks at which heat may be smoothly exchanged between fluids flowing in pipes of the fuel cell system and medium outside the pipes.

In an embodiment, the fuel cell system shown in FIG. 4 has a hybrid structure for supplying power output by at least one of the fuel cell 10 and the battery 32 to a load 33 based on change of output power of the fuel cell 10. The battery 32 functions as a power source for starting the fuel cell 10 or a power source for the load 33 together with the fuel cell 10. In the embodiment shown in FIG. 4 and other embodiments, the battery 32 may be a lithium battery, but not being limited thereto. In an alternative embodiment, the battery 32 may be a rechargeable capacitor with a large capacity. In an embodiment, the battery 32 may be installed either inside or outside the fuel cell system shown in FIG. 4. Accordingly, since a fuel cell system including a battery may independently produce power, the fuel cell system may be used as a portable fuel cell system.

The DC/DC converter 31 converts output voltage of the fuel cell 10 to a voltage according to control of the controller 30. Surplus power remaining after output power of the DC/DC converter 31 is supplied to the load 33 is used for charging the battery 32. The DC/DC converter 31 may change output voltage of the fuel cell 10 according to control of the controller 30, such that constant current is output from the fuel cell 10. In an embodiment, the fuel cell system is operated for the fuel cell 10 to output a constant current. In an alternative embodiment, the DC/DC converter 31 may change output voltage of the fuel cell 10 according to control of the controller 30, such that a constant voltage is input to the load 33. In such an embodiment, the fuel cell system is operated for the fuel cell 10 to output a constant voltage.

Although the peripheral devices stated above are generally operated using power provided by the fuel cell 10, that is, power output by the DC/DC converter 31, when the fuel cell 10 is unable to generate power or power generated by the fuel cell 10 is insufficient, the peripheral devices may be operated using power output by the battery 32. In an embodiment, no power is generated by the fuel cell 10 before the fuel cell 10 is started, and the battery 32 thereby supplies power for heating the fuel cell 10 and the peripheral devices, and supplies power for operating the peripheral devices while the fuel cell 10 and the peripheral devices are being heated. As described above, a semiconductor device such as a MOSFET consumes less power than conventional heating devices, such as a hot wire, a resistor, etc., and thus the fuel cell 10 may be started at a substantially low temperature using power charged to the battery 32. In FIG. 4, for convenience of illustration, only major power lines between the fuel cell 10, the DC/DC converter 31, the battery 32 and the load 33 are shown, and other power lines connected to the peripheral devices from the fuel cell 10 or the battery 32 are omitted.

The first heating module 101 and the first temperature sensor 201 are attached to the fuel cell 10, and the second heating module 102 and the second temperature sensor 202 are attached to the first separator 51. If temperature of the fuel cell 10 is not above a predetermined temperature, electrochemical reaction inside the fuel cell 10 does not occur smoothly. As the first separator 51 is for recovering water, if the fuel cell 10 is operated when the first separator 51 is frozen, high concentration fuel may be supplied to the fuel cell 10, and thus the fuel cell 10 may be deteriorated or malfunction. Therefore, in the embodiment shown in FIG. 4, the fuel cell 10 and the first separator 51 may be heated by the heating modules.

The first heating module 101 may be attached to a surface of the fuel cell 10 as shown in FIG. 3A or may be arranged inside the fuel cell 10. Although the efficiency of heating the fuel cell 10 arranged inside the fuel cell 10 may be relatively higher, a process for fabricating the fuel cell 10 inside the fuel cell 10 may be more complicated. Similarly, the second heating module 102 may be attached to a surface of the first separator 51 or may be arranged inside the first separator 51. The first temperature sensor 201 provides values for determining whether to operate the heating module 101, such that the temperature sensor 201 may be positioned substantially close to the first heating module 101. Similarly, the second temperature sensor 202 may be positioned substantially close to the second heating module 102. The above described attachments of the second heating module 102 and the second temperature sensor 202 are also applied to other heating modules and temperature sensors described below.

The first heating module 101 and the second heating module 102 are devices having the configuration as shown in FIGS. 3A to 3C and heat the fuel cell 10 and the first separator 51 using heat generated by MOSFETS attached to the fuel cell 10 and the first separator 51. The first temperature sensor 201 and the second temperature sensor 202 are attached to the fuel cell 10 and the first separator 51 and detect temperatures of the fuel cell 10 and the first separator 51, respectively. The controller 30 receives temperatures of the fuel cell 10 and the first separator 51 from the first temperature sensor 201 and the second temperature sensor 202, and may switch MOSFETs included in the first heating module 101 and the second heating module 102 by controlling voltages input to gates of the MOSFETs included in the first heating module 101 and the second heating module 102 based on the received temperature values. The controller 30 may control heat generation of the MOSFETs of the first heating module 101 and the second heating module 102 by switching the MOSFETs as described above. Therefore, the first heating module 101 and the second heating module 102 may heat the fuel cell 10 and the first separator 51 using heat generated by the MOSFETs attached to the fuel cell 10 and the first separator 51 based on temperatures detected by the first temperature sensor 201 and the second temperature sensor 202.

In an embodiment, if the controller 30 switches each MOSFET included in the first heating module 101 and the second heating module 102 by outputting pulse signal as shown in FIG. 2A, that is, signal of which voltage changes in a shape of pulse having a predetermined frequency to a gate of the each MOSFET included in the first heating module 101 and the second heating module 102, the first heating module 101 and the second heating module 102 heat the fuel cell 10 and the first separator 51 using heat generated by the each MOSFET that is switched substantially in proportion to the predetermined frequency of the signal. Therefore, the higher the frequency of the signal input to the gate of the each MOSFET included in the first heating module 101 and the second heating module 102 are, the higher the heat generating performances of the first heating module 101 and the second heating module 102 become.

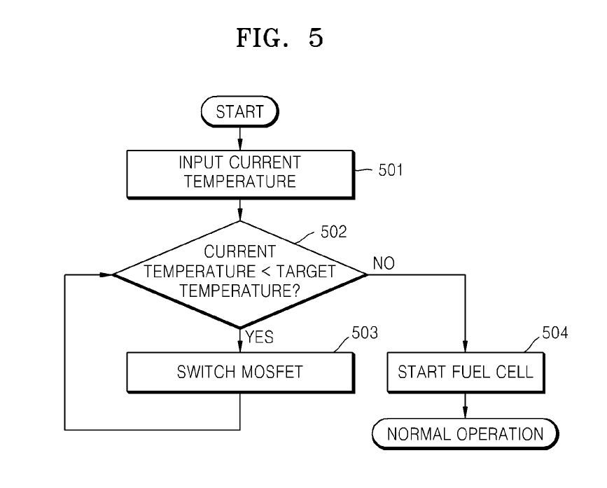

FIG. 5 is a flowchart showing an embodiment of a method of operating a fuel cell system at a low temperature according to the invention. Referring to FIG. 5, an embodiment of the method of operating a fuel cell system at a low temperature includes operations that are performed by the controller 30 shown in FIG. 4. Therefore, even if omitted below, any of descriptions given above in relation to the fuel cell system shown in FIG. 4 may also be applied to the method of operating a fuel cell system at a low temperature described below. Hereinafter, the method of operating the fuel cell system at a low temperature by the controller 30 shown in FIG. 4 will be described in detail with reference to FIG. 5.

In an embodiment, the controller 30 receives current temperatures of the fuel cell 10 and the first separator 51 from the temperature sensors 201 and 202, respectively (operation 501). Then, the controller 30 compares the temperatures received in the operation 501 to a target temperature (operation 502). In such an embodiment, the target temperature is the lowest temperature of the main components, that is, the fuel cell 10 and the first separator 51, at which the fuel cell system may be operated without affecting performance or durability of the fuel cell system. The target temperature may be determined by test-operating the fuel cell system inside a chamber in which temperature changes. In an embodiment, the fuel cell 10 and the first separator 51 may have different target temperatures. In one embodiment, for example, the target temperature of the fuel cell 10 may be the lowest temperature at which the fuel cell 10 may be started, whereas the target temperature of the first separator 51 may be the lowest temperature at which methanol and water may be separated from materials discharged by the fuel cell 10. As a result of the comparison of the temperature, if at least one of the current temperature of the fuel cell 10 and the current temperature of the first separator 51 is lower than the target temperature of the fuel cell 10, the method proceeds to switching the MOSFET (operation 503). If not, the method proceeds to starting the fuel cell 10 (operation 504).

In the operation 503, if the current temperature of the fuel cell 10 is lower than the target temperature of the fuel cell 10, the controller 30 induces heat generation of the MOSFET of the heating module 101 by switching the MOSFET of the first heating module 101, and, if the current temperature of the first separator 51 is lower than the target temperature of the first separator 51, the controller 30 induces heat generation of the MOSFET of the second heating module 102 by switching the MOSFET of the second heating module 102.

In an embodiment, temperature sensors may be to one of the fuel cell 10 and the first separator 51. In one embodiment, for example, one temperature sensor may be attached to one of the fuel cell 10 and the first separator 51, and heat generation of both of the first and second heating modules 101 and 102 may be controlled based on value detected by the one temperature sensor.

After the operation 503 is performed for a predetermined period of time, the method proceeds back to the operation 502 to determine whether the current temperatures of the fuel cell 10 and the first separator 51 reached the target temperatures. Signals output by the first and second temperature sensors 201 and 202 are continuously input to the controller 30, and thus, in the operation 502, the controller 30 compares temperatures increased in the operation 502 to the target temperatures, and the operation 503 is repeatedly performed until temperatures of main components reach temperatures at which the fuel cell system may be operated without affecting performance or durability of the fuel cell system.

In the operation 504, the controller 30 starts supplying fuel and air to the fuel cell 10 by starting to operate the feed pump 44 and the air pump 41 to start the fuel cell 10, and the controller 30 controls pumping operations of the feed pump 44 and the air pump 41 based on amounts of fuel and air to be supplied for warming up the fuel cell 10. In an embodiment, the feed pump 44 and the air pump 41 may be controlled using various methods. In one embodiment, for example, the controller 30 may adjust amounts of methanol and air pumped by the feed pump 44 and the air pump 41 by maintaining pumping speed of the feed pump 44 and the air pump 41 constant and adjusting on/off rate of the pumping operations. In an alternative embodiment, the controller 30 may adjust amounts of methanol and air pumped by the feed pump 44 and the air pump 41 by adjust pumping speed of the feed pump 44 and the air pump 41 constant and maintaining on state of the pumping operations. After the fuel cell 10 is started, the fuel cell system may be normally operated.

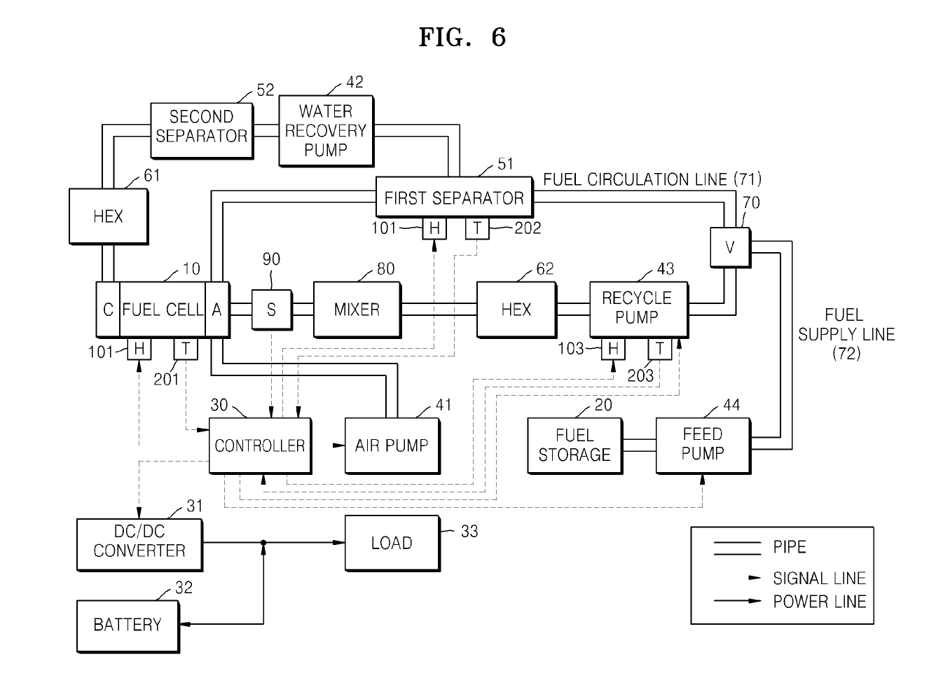

FIG. 6 is a diagram showing an alternative embodiment of a fuel cell system according to the invention. Referring to FIG. 6, an embodiment of the fuel cell system may further include a third heating module 103 and a third temperature sensor 203 other than the components in the embodiment shown in FIG. 4. Therefore, any repetitive detailed descriptions of the components identical to those in the embodiment shown in FIG. 4 will be omitted below.

The third heating module 103 and the third temperature sensor 203 are attached to the recycle pump 43. If the fuel cell system is kept at an extremely low temperature environment for a long time, substantially all components containing low-concentration fuel may be frozen, except the fuel supply line 72, the fuel storage 20 and the feed pump 44 containing high-concentration fuel. Although the fuel cell 10 and the first separator 51 are heated by the first and second heating modules 101 and 102 in the embodiment shown in FIG. 4, components and pipes, in which low concentration fuel remain, may not be defreezed or may take long time to be defreezed when temperatures of the fuel cell 10 and the first separator 51 are increased.

Therefore, in the embodiment shown in FIG. 6, if temperatures of the main components of the fuel cell system are very low, fluid remaining in the fuel cell system is circulated by heating and operating the recycle pump 43, such that components and pipes located on a path in which the fluid is circulated are warmed. In such an embodiment, the fluid remaining in the fuel cell system includes remaining fuel not yet supplied to the fuel cell 10 and materials discharged by the fuel cell 10. Accordingly, as the fluid of which temperature is increased inside the recycle pump 43 is recycled in the fuel cell system, temperatures of the components other than the fuel storage 20 and the feed pump 44 on the fuel supply line 72 and pipes interconnecting fuel cell 10 and the components increase. In such an embodiment, additional heating modules may be attached to the pipes to increase temperatures of the pipes faster.

In an embodiment, a MOSFET included in at least one of the heating modules 101, 102 and 103, may be shared by an electric circuit included in a peripheral device. If temperatures of peripheral devices to which the heating modules 101, 102 and 103 are attached are lower than a predetermined temperature, the MOSFET may be used to heat the peripheral devices, and, after the fuel cell 10 is started, the MOSFET may be used for operating the peripheral devices including electric circuits to which the MOSFET is applied. In one embodiment, for example, the heating module 103 and an operating circuit of the recycle pump 43 may share at least one MOSFET. In such an embodiment, if temperature of the recycle pump 43 is lower than a predetermined temperature, the MOSFET may be used to heat the recycle pump 43, and, after the fuel cell 10 is started, the MOSFET may be used for controlling on/off rate of pumping operation or pumping speed of the recycle pump 43. Accordingly, as a MOSFET already applied to the fuel cell system is used for generating heat, additional MOSFET for controlling temperature of the fuel cell system may be omitted such that operation of a fuel cell system at a low temperature may be embodied at low cost without significantly changing size of the fuel cell system.

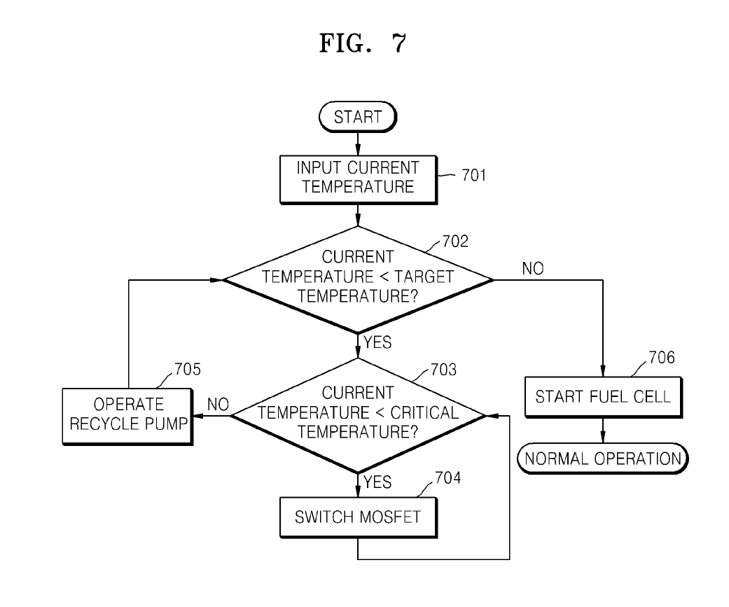

FIG. 7 is a flowchart showing an alternative embodiment of a method of operating a fuel cell system at a low temperature according to the invention. Referring to FIG. 7, the method of operating a fuel cell system according to the embodiment includes operations that are performed by the controller 30 shown in FIG. 6. Therefore, even if omitted below, any of descriptions given above in relation to the fuel cell system shown in FIG. 6 may also be applied to the method of operating a fuel cell system at a low temperature described below. Hereinafter, the method of operating the fuel cell system 4 at a low temperature by the controller 30 shown in FIG. 6 will be described in detail with reference to FIG. 7.

In an embodiment, the controller 30 receives current temperatures of the fuel cell 10, the first separator 51 and the recycle pump 43 from the temperature sensors 201, 202 and 203, respectively (operation 701). Then, the controller 30 compares the temperatures received in the operation 701 to a target temperature, e.g., a second predetermined temperature (operation 702). As a result of the comparison in the operation 702, if at least one of the current temperature of the fuel cell 10, the current temperature of the first separator 51, and the current temperature of the recycle pump 43 is lower than the target temperature of the fuel cell 10, the method proceeds to compare the temperatures received in the operation 701 to a critical temperature, e.g., a first predetermined temperature (operation 703). If not, the method proceeds to starting fuel cell (operation 706). In the operation 703, the controller 30 compares the temperatures received in the operation 701 to a critical temperature. In such an embodiment, the critical temperature is the lowest temperature of the main components, that is, the fuel cell 10, the first separator 51 and the recycle pump 43, at which fluid remaining in the fuel cell system may be circulated by pumping of the recycle pump 43. The critical temperature may be determined by test-operating the fuel cell system inside a chamber in which temperature changes

As a result of the comparison in the operation 703, if at least one of the current temperatures of the fuel cell 10, the current temperature of the first separator 51 and the current temperature of the recycle pump 43 are lower than the critical temperature, the method proceeds to switching MOSFET (operation 704). If not, the method proceeds to operation of recycle pump (operation 705). Generally, temperature of a fuel cell system kept for a long time at an extremely low temperature is lower than the critical temperature.

In the operation 704, if the current temperature of the fuel cell 10 is lower than the critical temperature of the fuel cell 10, the controller 30 induces heat generation of the MOSFET of the first heating module 101 by switching the MOSFET of the first heating module 101, if the current temperature of the first separator 51 is lower than the target temperature of the first separator 51, the controller 30 induces heat generation of the MOSFET of the second heating module 102 by switching the MOSFET of the second heating module 102, and, if the current temperature of the recycle pump 43 is lower than the target temperature of the recycle pump 43, the controller 30 induces heat generation of the MOSFET of the third heating module 103 by switching the MOSFET of the third heating module 103. In an embodiment, temperature sensors may be attached to the fuel cell 10, the first separator 51 or the recycle pump 43. In one embodiment, for example, one temperature sensor may be attached to one of the fuel cell 10, the first separator 51 and the recycle pump 43, and heat generation of all of the heating modules 101, 102 and 103 may be controlled based on value detected by the one temperature sensor.

After the operation 704 is performed for a predetermined period of time, the method proceeds back to the operation 703 to determine whether the current temperatures of the fuel cell 10, the first separator 51 and the recycle pump 43 reached the critical temperatures. Signals output by the temperature sensors 201, 202 and 203 are continuously input to the controller 30, and thus, in the operation 703, the controller 30 compares temperatures increased in the operation 703 to the critical temperatures, and the operation 704 is repeatedly performed until temperatures of main components reach temperatures at which fluid remaining in the fuel cell system can be circulated through the recycle pump 43.

In an operation 705, the controller 30 operates the recycle pump 43 to circulate fluid remaining in the fuel cell system, such that components and pipes located on a path in which the fluid is circulated are warmed. After the operation 705 is performed for a predetermined period of time, the method proceeds back to the operation 702 to determine whether the current temperatures of the fuel cell 10, the first separator 51 and the recycle pump 43 reached the target temperatures. In the operation 706, the controller 30 starts supplying fuel and air to the fuel cell 10 by starting to operate the feed pump 44 and the air pump 41 to start the fuel cell 10 and controls pumping operations of the feed pump 44 and the air pump 41 based on amounts of fuel and air to be supplied for warming up the fuel cell 10. After the fuel cell 10 is started, the fuel cell system may be normally operated.

After the fuel cell 10 is started and the fuel cell system is in normal operation mode, the controller 30 may operate a peripheral device including an electric circuit having applied thereto a MOSFET by outputting a signal different from that shown in FIG. 2A to a MOSFET included in at least one of the heating modules 101, 102 and 103.

In one embodiment, for example, the third heating module 103 and the operating circuit of the recycle pump 43 may share at least one MOSFET. In such an embodiment, after the fuel cell 10 is started, the controller 30 may output a signal indicating on/off rate of pumping operations or pumping speed of the recycle pump 43, such that the motor of the recycle pump 43 rotates at the on/off rate or the pumping speed.

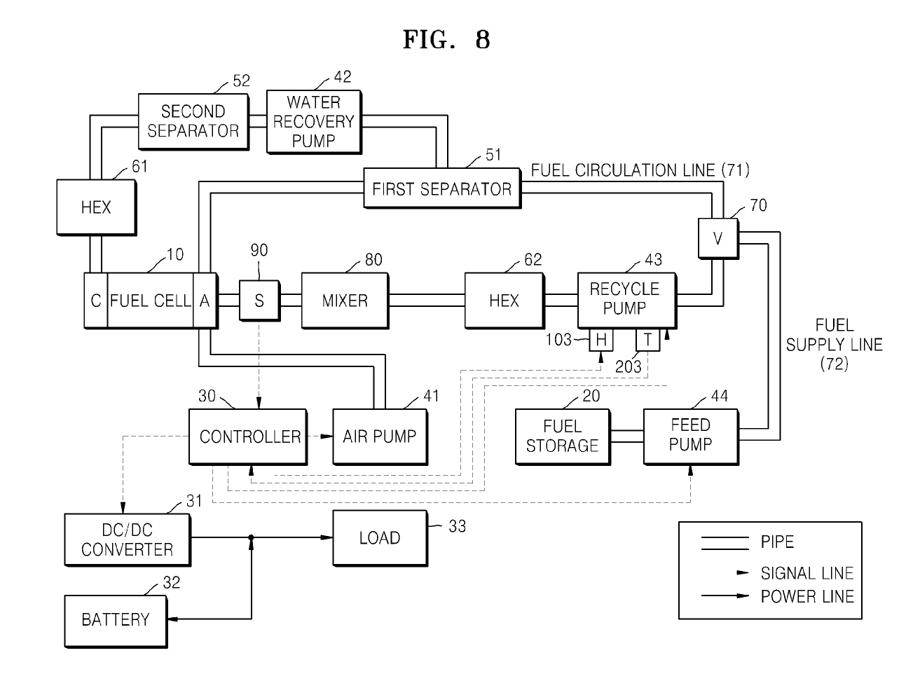

FIG. 8 is a diagram showing another alternative embodiment of a fuel cell system according to the invention. Referring to FIG. 8, an embodiment of the fuel cell system includes all of the components of the fuel cell system shown in FIG. 6 except the first and second heating modules 101 and 102 and the first and second temperature sensors 201 and 202. Therefore, any repetitive descriptions of the components identical to those in the embodiment shown in FIG. 6 will be omitted below.

As described above, when the recycle pump 43 is operated, fuel is circulated through the components other than the fuel storage 20 and the feed pump 44 on the fuel supply line 72 and pipes interconnecting fuel cell 10 and the components. High-concentration fuel is remaining in the fuel storage 20 and the feed pump 44 on the fuel supply line 72, and may not be frozen under almost any environments existing on the Earth. If substantially great amount of heat is generated from the third heating module 103, the entire fuel cell system may be defreezed only by operating the recycle pump 43. Therefore, in the embodiment shown in FIG. 8, the third heating module 103 and the third temperature sensor 203 are attached to the recycle pump 43. In an alternative embodiment, a temperature sensor may be additionally attached to the fuel cell 10 to determine whether to start the fuel cell 10 based on the temperature of the fuel cell 10.

In an embodiment, as shown in FIG. 2B and FIG. 2C, to improve heat generating performance of the heating module 103, a plurality of MOSFETs may be included in one heating module. The plurality of MOSFETs may be MOSFETs already applied to the fuel cell system. In one embodiment, for example, if a brushless motor is applied to the recycle pump 43, the operating circuit of the brushless motor includes a plurality of MOSFETs. In such an embodiment, the third heating module 103 and the operating circuit of the recycle pump 43 may share the plurality of MOSFETs.

In an embodiment, the DC/DC converter 31 may also include a plurality of MOSFETs, and thus the third heating module 103 and the DC/DC converter 31 may share the plurality of MOSFETs. In an embodiment, if the temperature of the recycle pump 43 is lower than a predetermined temperature, the DC/DC converter 31 functions as the heating module 103. In such an embodiment, a target heated by the heating module 103 is different from a target which shares MOSFETs with the heating module 103, and the DC/DC converter 31 is attached to the recycle pump 43. While the DC/DC converter 31 is functioning as the heating module 103, if power is supplied from the battery 32 to the DC/DC converter 31, large voltage or current that may induce malfunction of the fuel cell system or load may be output by the DC/DC converter 31. Therefore, while the DC/DC converter 31 is functioning as the heating module 103, a switch for cutting connecting between the fuel cell 10 and the DC/DC converter 31 may be arranged between the fuel cell 10 and the DC/DC converter 31. In such an embodiment, another switch for cutting connecting between the load 33 and the DC/DC converter 31 may be arranged between the load 33 and the DC/DC converter 31.

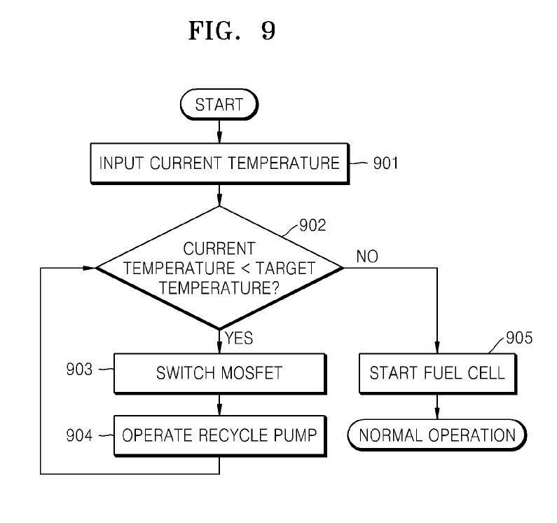

FIG. 9 is a flowchart showing another alternative embodiment of a method of operating a fuel cell system at a low temperature according to the invention. Referring to FIG. 9, the method of operating a fuel cell system includes operations that are performed by the controller 30 shown in FIG. 8. Therefore, even if omitted below, any of descriptions given above in relation to the fuel cell system shown in FIG. 8 may also be applied to the method of operating a fuel cell system at a low temperature described below. Hereinafter, the method of operating the fuel cell system at a low temperature by the controller 30 shown in FIG. 8 will be described in detail with reference to FIG. 9.

In an embodiment, the controller 30 receives current temperature of the recycle pump 43 from the third temperature sensor 203 (operation 901). Then, the controller 30 compares the temperature received in the operation 901 to a target temperature (operation 902). As a result of the comparison in the operation 902, if the current temperature of the recycle pump 43 is lower than the target temperature of the fuel cell 10, the method proceeds to switching MOSFET (operation 903). If not, the method proceeds to starting fuel cell (operation 905).

In the operation 903, the controller 30 induces heat generation of the MOSFET of the third heating module 103 attached to the recycle pump 43 by switching the MOSFET of the third heating module 103. Next, the controller 30 operates the recycle pump 43 to circulate fluid remaining in the fuel cell system (operation 904), such that components and pipes located on a path in which the fluid is circulated are warmed. After the operations 903 and 904 are performed for a predetermined period of time, the method proceeds back to the operation 902 to determine whether the current temperature of the recycle pump 43 reached the target temperatures. Signals output by the temperature sensor 203 are continuously input to the controller 30, and thus, in the operation 902, the controller 30 compares temperatures increased in the operations 903 and 904 to the target temperature, and the operations 903 and 904 are repeatedly performed until temperatures of main components reach temperature at which the fuel cell system may be operated without affecting performance or durability of the fuel cell system.

In an embodiment, the controller 30 starts supplying fuel and air to the fuel cell 10 by starting to operate the feed pump 44 and the air pump 41 to start the fuel cell 10 and controls pumping operations of the feed pump 44 and the air pump 41 based on amounts of fuel and air to be supplied for warming up the fuel cell 10 (operation 905). After the fuel cell 10 is started and the fuel cell system is in normal operation mode, the controller 30 may operate a peripheral device including an electric circuit having applied thereto a MOSFET by outputting a signal different from that shown in FIG. 2A to a MOSFET included in the heating module 103. In one embodiment, for example, the third heating module 103 and the DC/DC converter 31 may share a plurality of MOSFETs. In such an embodiment, after the fuel cell 10 is started, the controller 30 may control voltage conversion of the DC/DC converter 31 by outputting a signal indicating voltage converting ratio of the DC/DC converter 31.

According to the embodiments described above, by heating the fuel cell 10, the peripheral devices, and pipes interconnecting the fuel cell 10 and the peripheral devices using heat generation of MOSFETs, the fuel cell 10 may be started at an extremely low temperature only with power charged to the battery 32. In such embodiments, by heating the fuel cell 10, the peripheral devices and pipes interconnecting the fuel cell 10 and the peripheral devices using heat generation of MOSFETs that are already applied to a fuel cell system, operation of a fuel cell system at a low temperature may be embodied at low cost without significantly changing size of the fuel cell system.

The embodiments of the invention may be written as computer programs and may be implemented in general-use digital computers that execute the programs using a computer readable recording medium. In an embodiment, the computer readable recording medium may include magnetic storage media, e.g., read-only memory (“ROM”), floppy disks, hard disks, etc., optical recording media, e.g., compact disc-read-only memories (“CD-ROM”s), or digital versatile discs (“DVD”s), etc.

It should be understood that the embodiments described therein should be considered in a descriptive sense only and not for purposes of limitation. Descriptions of features or aspects within each embodiment should typically be considered as available for other similar features or aspects in other embodiments.

What is claimed is:

1. A fuel cell system comprising:
a fuel cell which generates power using a fuel;
peripheral devices for operating the fuel cell and supplying the power generated by the fuel cell to loads; and
a heating module which heats at least one of the fuel cell and the peripheral devices using heat generated by a semiconductor device attached to the at least one of the fuel cell and the peripheral devices.

2. The fuel cell system of claim 1, wherein
the semiconductor device is a transistor, and
the heating module heats the at least one of the fuel cell and the peripheral devices using heat generated by the transistor while the transistor is being switched.

3. The fuel cell system of claim 2, wherein
the peripheral devices comprise a controller which controls heat generation of the semiconductor device by switching the transistor by outputting a pulse signal, a voltage of which changes in a shape of pulse having a predetermined frequency, to the transistor, and
the heating module heats the at least one of the fuel cell and the peripheral devices using the heat generated by the transistor, which is switched substantially in proportion to the predetermined frequency.

4. The fuel cell system of claim 2, wherein the transistor is a metal oxide semiconductor field effect transistor.

5. The fuel cell system of claim 1, further comprising:
a temperature sensor which is attached to the at least one of the fuel cell and the peripheral devices and detects a temperature of the at least one of the fuel cell and the peripheral devices,
wherein the heating module heats the at least one of the fuel cell and the peripheral devices using the heat generated by the semiconductor device based on the temperature detected by the temperature sensor.

6. The fuel cell system of claim 5, wherein
the peripheral devices comprise a controller which compares the temperature detected by the temperature sensor to a predetermined temperature and controls heat generation of the semiconductor device based on a result of the comparison.

7. The fuel cell system of claim 6, wherein
the controller induces the heat generation of the semiconductor device if the temperature detected by the temperature sensor is lower than the predetermined temperature, and
the controller starts the fuel cell if the temperature detected by the temperature sensor is not lower than the predetermined temperature.

8. The fuel cell system of claim 6, wherein
the peripheral devices comprise a predetermined pump, and a controller which operates the predetermined pump based on the temperature of the at least one of the fuel cell and the peripheral devices to circulate a fluid remaining in the fuel cell system, such that the peripheral devices and pipes on a path, in which the fluid is recycled, are warmed.

9. The fuel cell system of claim 1, wherein
the semiconductor device is shared by an electric circuits included in the heating module and an electric circuits included in a peripheral device of the peripheral devices,
if a temperature of the at least one of the fuel cell and the peripheral devices is lower than a predetermined temperature, the semiconductor device is used to heat the at least one of the fuel cell and the peripheral devices, and,
after the fuel cell is started, the semiconductor device is used for operating the peripheral device including the electric circuit.

10. The fuel cell system of claim 9, wherein the peripheral device is a recycle pump which circulates a fuel in a predetermined path inside the fuel cell system, and
the electric circuit included in the peripheral device is an operation circuit of the recycle pump.

11. A method of operating the fuel cell system, the method comprising:
receiving a temperature of at least one of a fuel cell and peripheral devices of the fuel cell system;
comparing the received temperature to a first predetermined temperature; and
controlling heat generation of a semiconductor device attached to the at least one of the fuel cell and the peripheral devices based on a result of the comparison.

12. The method of claim 11, wherein
the semiconductor device is a transistor, and
the controlling the heat generation of the semiconductor device comprises switching the transistor by controlling a voltage input to the transistor based on the result of the comparison.

13. The method of claim 12, wherein the switching the transistor comprises outputting a pulse signal, a voltage of which changes in a shape of a pulse having a predetermined frequency to the transistor, based on the result of the comparison.

14. The method of claim 12, wherein the transistor is a metal oxide semiconductor field effect transistor.

15. The method of claim 11, further comprising:
inducing heat generation of the semiconductor device if the received temperature is lower than the first predetermined temperature; and
starting the fuel cell, if the received temperature is not lower than the first predetermined temperature.

16. The method of claim 15, further comprising:
if the received temperature is lower than the first predetermined temperature, inducing the heat generation of the semiconductor device by outputting a pulse signal, a voltage of which changes in a shape of a pulse having a predetermined frequency, to the semiconductor device, and
after the fuel cell is started, operating a peripheral device of the peripheral devices having an electric circuit, to which the semiconductor device is applied, by outputting a signal different from the pulse signal outputted to the semiconductor device.

17. The method of claim 11, further comprising:
comparing the received temperature to a second predetermined temperature higher than the first predetermined temperature; and
if the received temperature is lower than the second predetermined temperature and is not lower than the first predetermined temperature, warming the peripheral devices and pipes on a path, in which a fluid remaining in the fuel cell system is circulated by circulating the fluid, by operating a predetermined pump from among the peripheral devices.

18. The method of claim 17, further comprising:
starting the fuel cell, if the received temperature is not lower than the second predetermined temperature.

19. The method of claim 11, further comprising:
if the received temperature is lower than the first predetermined temperature, inducing heat generation of the semiconductor device, wherein the semiconductor is attached to a predetermined pump from among the peripheral devices; and
warming the peripheral devices and pipes on a path, in which the fluid remaining in the fuel cell system is circulated by circulating the fluid, by operating the predetermined pump heated by the semiconductor device.

20. A computer readable recording medium having recorded thereon a computer program for implementing a method of operating a fuel cell system, the method comprising:
receiving a temperature of at least one of a fuel cell and peripheral devices of the fuel cell system;
comparing the received temperature to a predetermined temperature; and
controlling heat generation of a semiconductor device attached to the at least one of the fuel cell and the peripheral devices based on a result of the comparison.
